(19) United States
(12) Patent Application Publication
(10) Pub. No.: US 2008/0175813 A1
(43) Pub. Date: Jul. 24, 2008

(54) NOVEL ATTRACTANTS FOR VESPID WASPS

(75) Inventors: Ervin Kovacs, Vancouver (CA); John H. Borden, Burnaby (CA)

Correspondence Address: OYEN, WIGGS, GREEN & MUTALA LLP;480 - THE STATION, 601 WEST CORDOVA STREET, VANCOUVER, BC, V6B 1G1, omitted

(73) Assignee: PHEROTECH INTERNATIONAL INC., Delta (CA)

(21) Appl. No.: 12/018,336

(22) Filed: Jan. 23, 2008

Related U.S. Application Data
(60) Provisional application No. 60/886,355, filed on Jan. 24, 2007.

(51) Int. Cl. A01N 25/00; A01P 19/00

(52) U.S. Cl. 424/84

(57) ABSTRACT

This invention relates to novel methods and compositions, wherein chopped dried apple or apple pomace can be used as supplementary lures for trapping wasps in the family Vespidae in combination with volatile chemical attractants, including (but not limited to) heptyl butyrate, acetic acid and isobutanol. Said vespid wasps may be in the genera Vespa, Vespula, Dolichovespula or Polistes. When formulated in a porous bag immersed in a water-detergent capture medium at the bottom of the interior chamber of an Oak Stump trap, either chopped dried apple or apple pomace can increase the capture of said vespid wasps several fold.

### FIELD OF THE INVENTION

This invention pertains to novel methods and compositions, wherein two food-grade substances, chopped dried apples and apple pomace, are used to improve the attractiveness of traps for wasps in the Family Vespidae. Placing either substance in water at the bottom of the interior chamber of an Oak Stump trap, that is also baited with a lure releasing heptyl butyrate, or some other proven volatile attractant, increases the capture of wasps in that trap several fold. In particular, a supplementary lure comprised of apple pomace in a porous bag represents an easily manufactured, durable and persistently effective device that can be adopted as a commercial product.

### BACKGROUND OF THE INVENTION

Vespid wasps (Hymenoptera: Vespidae) (some informal names are yellowjackets, hornets, paper wasps) in the genera Vespa, Vespula, Dolichovespula and Polistes are major medically important pests that inflict painful stings on humans (Akre et al. 1981; Akre 1995). Numerous pest control tactics have been developed to lessen the impact of these wasps (Lyon 1997; Landolt and Antonelli 2003). One prominent tactic is to capture adult wasps in traps baited with various substances or known attractive chemicals.

Traps for vespulid wasps generally comprise the following elements: an entryway, e.g. an inward-facing cone, that facilitates entry into the trap but impedes exit; an interior chamber; water with detergent added at the bottom of the chamber to capture and drown wasps that have entered the trap (one commercial trap allows trapped wasps to gradually die in the air); and a lure that is either suspended from the ceiling of the interior chamber or is added to the water at the bottom of the trap. In some cases, the water at the bottom of the trap is replaced by another substance, e.g. apple juice, which serves as both a lure and a capture medium.

One very effective entryway design is embodied in the Oak Stump trap (Peters 1989). It consists of a transverse tube open at both ends spanning the diameter of the interior chamber. A cut out portion at mid-point of the tube allows wasps to enter the interior chamber in response to an attractive lure. A modification of this design removes the middle of the transverse tube, leaving two shorter lateral tubes opening into the interior chamber. Once inside the interior chamber, most wasps fly toward light shining through the transparent walls of the interior chamber, and do not find their way out. They soon contact the water capture medium at the bottom of the trap and drown. In Rhode Island, Christie (1994) found the Oak Stump trap to be superior to other commercial traps, including Victor traps, Consep traps, the Green Leaf trap and the Yellowjacket Inn.

In the applicants' studies in British Columbia, a heptyl butyrate lure was used in dry Rescue traps, Victor traps, Pic traps and Oak Stump traps. The latter was found to be far superior in capturing the western yellowjacket, Vespula pennsylvanica. We also found the Oak Stump trap with a heptyl butyrate lure to be superior to the disposable Rescue trap with a commercial lure.

Numerous chemical attractants have been identified for yellowjackets and other wasps in the Family Vespulidae. The most well known and widely used attractant in commercial traps is heptyl butyrate, which is highly attractive to several species, most notably Vespula pennsylvanica (Davis et al. 1969; Macdonald et al. 1973), which is the principal vespid pest in western North America. Other species attracted to heptyl butyrate include Vespula atropilosa (Macdonald et al. 1973), Vespula acadica, Vespula consobrina and Vespula rufa (Landolt et al. 2005). However, heptyl butyrate is only a weak attractant for several species, and some do not respond to it at all. Most of these species respond to acetic acid alone or in combination with isobutanol (Landolt 2000). Among the species that are attracted to the blend of acetic acid and isobutanol are several important pests, including the German yellowjacket, Vespula germanica, the eastern yellowjacket, Vespula maculifrons, the southern yellowjacket, Vespula squamosa, and other less important pests, including Vespula vulgaris, Vespula flavopilosa, Dolichovespula maculata, Polistes aurifer and Polistes fuscatus (Landolt 1995; Day and Jeanne 2001; Landolt et al. 2000; 2005).

Some species, e.g. Vespula pennsylvanica and Vespula squamosa, respond to both heptyl butyrate and a blend of acetic acid and isobutanol (Landolt 1998; Landolt et al. 2003). Aldrich (2004) found a blend of heptyl butyrate+(E)-2-hexenal diethyl acetal+α-terpineol+benzyl alcohol to be highly effective in trapping Vespula maculifrons. Aldrich (2004) also found synergism between several blends of compounds and a blend of acetic acid and isobutanol as follows: (E)-2-hexenal diethyl acetal+α-terpineol, (E)-2-hexenal diethyl acetal+linalool, (E)-2-hexenal diethyl acetal+α-terpineol+benzyl alcohol, and (E)-2-hexenal diethyl acetal+linalool+benzyl alcohol for Vespula maculifrons, and (E)-2-hexenal diethyl acetal+linalool+benzyl alcohol for Vespula squamosa, Vespula germanica and Vespula flavopilosa.

Substances, with unknown active ingredients used as lures in baited traps include pet food (Chang 1988; Ross et al. 1984), processed meats (Wood et al. 2006), poultry liver (Long 2003), powdered egg (Long 2003), citrus-based carbonated beverages (Wegner and Jordan 2005), grenadine (Christie 1992), and frozen apple juice concentrate, which is an effective and widely recommended lure (Lyon 1997). These substances are inconvenient for purchasers of commercial traps to use, because the user must also procure or purchase one or more of these substances.

An objective of the inventors was to identify an inexpensive substance that could be sold as a commercial lure, and could be employed in the Oak Stump trap as a novel supplement to lures emitting one or more of the known volatile chemical attractants. One potential substance that could replace apple juice is dried apples. Another is apple pomace (also known as apple pumice), the residual material (seeds, stem, flesh and peel) left after pressing apples for juice (Carson et al. 1994; Boyer and Liu 2004). It represents about 25-35% of the fresh weight of processed apples (Bhalla and Joshi 1994), and has a sugar content of 9-22% (Hang et al. 1981). Although underutilized, it has utility as a food ingredient (Carson et al. 1994), and as a source of biofuels such as ethanol (Hang et al. 1981) and certain chemicals, including polyphenol antioxidants (Lu and Foo 2000).

The foregoing examples of the related art and limitations related thereto are intended to be illustrative and not exclusive. Other limitations of the related art will become apparent to those of skill in the art upon a reading of the specification.

### SUMMARY OF THE INVENTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification is to be regarded in an illustrative, rather than a restrictive, sense.

The invention is directed to novel methods of improving the capture of wasps in the Family Vespidae in traps baited with volatile chemical attractants. In one aspect, the methods pertain to using chopped dried apple or apple pomace (also referred to as apple pumice) as supplementary lures in combination with volatile chemical attractants that include (but are not limited to) heptyl butyrate, acetic acid and isobutanol.

In a second aspect, the vespid wasps can be caught in an Oak Stump trap, comprising a transparent cylindrical or globular receptacle with a replaceable air-tight lid, lateral entry ports leading into a transverse tube that spans the diameter of the trap and which has a partial or wholly cut-out portion at the mid point of the tube, thereby allowing wasps to enter the large interior chamber, and a water-detergent capture medium at the bottom of the interior chamber, in which wasps are captured and drowned.

In a third aspect, an effective amount of the chopped dried apple or apple pomace is contained in a porous bag immersed in the water-detergent capture medium at the bottom of the interior chamber of the trap.

In a final aspect, said vespid wasps include (but are not limited to) Vespula pennsylvanica, Vespula germanica, Vespula maculifrons, Vespula squamosa, Vespula flavopilosa, Vespula atropilosa, Vespula acadica, Vespula consobrina, Vespula rufa, Vespula vulgaris, Dolichovespula maculata, Polistes aurifer, Polistes fuscatus, Polistes dominulus and Vespa crabro.

The invention is also directed to novel compositions designed to improve the capture of wasps in the Family Vespidae in Oak Stump traps baited with volatile chemical attractants that include (but are not limited to) heptyl butyrate, acetic acid and isbutanol.

The novel compositions also include supplementary lures comprised of chopped dried apple or apple pomace contained in porous bags immersed in the water-detergent capture medium at the bottom of the interior chamber of the trap. Said compositions can be used to capture vespid wasps that include (but are not limited to) Vespula pennsylvanica, Vespula germanica, Vespula maculifrons, Vespula squamosa, Vespula flavopilosa, Vespula atropilosa, Vespula acadica, Vespula consobrina, Vespula rufa, Vespula vulgaris, Dolichovespula maculata, Polistes aurifer, Polistes fuscatus, Polistes dominulus and Vespa crabro.

### DETAILED DESCRIPTION OF THE INVENTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

### EXAMPLE 1

### Test of Chopped Apples as a Supplement for Heptyl Butyrate

The inventors first hypothesized that dried apples would be a suitable substitute for apple juice or any of the other substances used as lures for vespid wasps. We reasoned that a portion of dried apples could be packaged and sent as a lure to consumers along with the standard heptyl butyrate lure. This hypothesis was tested in Experiment 1.

The experiment was run for 3 days in Tilbury Industrial Park in Delta, B.C. from 8-11 Sep. 2006. Large 2 L Oak Stump traps, with a single transverse entry tube, and 300-350 mL of water with 2-3 drops of liquid detergent added in the bottom of the interior chamber, were hung at eye level from trees or woody bushes. Traps for each of three treatments were deployed in 12 randomized complete blocks, with ≧5 m between traps. Treatments were: 1) a single heptyl butyrate flex lure (Pherotech International Inc.) suspended from the trap lid inside the interior chamber, 2) 12 g of finely chopped dried apples (bulk product, Save-on-Foods, Vancouver, B.C.) added to the water at the bottom of each trap, and 3) both treatments combined. At the end of the 3 h duration of the experiment, the traps were taken down, the contents emptied through a kitchen strainer that separated solid matter (including captured wasps and chopped apple) from the water-detergent capture medium, and the captured wasps counted.

Almost all captured wasps were western yellowjackets, Vespula pennsylvanica. The very few Polistes spp. captured (no more than two per trap, with most traps having none) were not counted. Of the 2,568 Vespula pennsylvanica captured, only 62 were in traps baited only with chopped dried apples (Table 1). Traps with heptyl butyrate lures alone captured on average 73 yellowjackets. Traps with both stimuli captured significantly more yellowjackets than traps baited with either of the other two lures, thereby demonstrating unexpected synergism between the heptyl butyrate and apple stimuli.

TABLE 1
Results of Experiment 1 (N = 12), demonstrating synergism between
apple slices immersed in capture water at bottom of Oak Stump trap
and heptyl butyrate lure suspended from trap ceiling in numbers
of Vespula pennsylvanica captured.

| | MEAN NUMBER OF WASPS |
|---|---|
| TREATMENT | CAPTURED ± SE^{a} |
| Dried apple slices alone | 5.2 ± 2.6 a |
| Heptyl butyrate alone | 72.8 ± 13.9 b |
| Heptyl butyrate + apple slices | 136.0 ± 27.4 c |

^{a}Means followed by the same letter are not significantly different, Mann-Whitney sign rank test on proportional catch data, P ≦ 0.05.

This experiment demonstrates that dried apple can be a potential supplement for the heptyl butyrate lure. However, for commercial purposes, the dried apple is fairly expensive. Moreover, the pieces rapidly imbibe water and swell, making it hard to see the captured wasps, and adding to the problem of disposing of the trap contents.

Therefore, the inventors continued their research by investigating apple pomace as a potential supplement to heptyl butyrate.

### EXAMPLE 2

### Comparison of Apple Pomace and Chopped Dried Apples as Supplements for Heptyl Butyrate

Experiment 2, with 15 replicates, was run at the same location as Experiment 1 from 15-18 Sep. 2006. Trap position, experimental layout and processing of captured wasps were the same as described for Experiment 1. Three treatments were tested: 1) heptyl butyrate alone, 2) heptyl butyrate plus 12 g of chopped dried apples as above, and 3) heptyl butyrate plus 12 g of apple pomace added to the detergent-laced water at the bottom of the interior chamber. The apple pomace was obtained from Agrisource Food Products Inc., Richmond, B.C. The chopped dried apples and the apple pomace were wrapped in plastic mesh (3 mm hexagonal weave) to separate the bait stimuli from the captured wasps.

Again almost all wasps captured were Vespula pennsylvanica. Although 73% more wasps were caught in traps baited with heptyl butyrate plus apple pomace, the mean numbers captured in this treatment and in traps baited with heptyl butyrate alone were not significantly different (Table 2). However, surprisingly, only traps with the combined heptyl butyrate plus apple pomace lures caught significantly more wasps than traps baited with heptyl butyrate plus chopped dried apple.

TABLE 2
Results of Experiment 2 (N = 15), showing over two time more Vespula
pennsylvanica captured in traps baited with heptyl butyrate + apple
pomace than in traps baited with heptyl butyrate + apple slices.

| | MEAN NUMBER OF WASPS |
|---|---|
| TREATMENT | CAPTURED ± SE^{a} |
| Heptyl butyrate alone | 15.7 ± 3.4 ab |
| Heptyl butyrate + apple slices | 13.5 ± 2.5 a |
| Heptyl butyrate + apple pomace | 27.1 ± 5.3 b |

^{a}Means followed by the same letter are not significantly different, ANOVA on data transformed by log x + 1.5 followed by Tukey-Kramer HSD test, P ≦ 0.05.

The lack of synergism between heptyl butyrate and chopped dried apple as in Experiment 1 may be due to wasps being diverted by the superior attractiveness of traps baited with the heptyl butyrate plus apple pomace lures. However, the results of this experiment definitely show that apple pomace is a significantly better supplement for heptyl butyrate than chopped dried apple.

### EXAMPLE 3

### Comparison of Wet and Dry Apple Pomace as Supplements for Heptyl Butyrate

Experiment 3 was designed to test whether the apple pomace was equally active when placed in a trap dry, or if it needed to be immersed in the capture water at the bottom of the trap. The experiment ran from 21-22 Sep. 2006, at the same location as the first two experiments. All other experimental conditions were the same as above. Twelve replicates of three treatments were tested: 1) heptyl butyrate alone, 2) heptyl butyrate plus a mesh bag containing 12 g of apple pomace suspended dry from the trap lid along with the heptyl butyrate lure, and 3) heptyl butyrate plus 12 g of apple pomace in a mesh bag immersed in the water-detergent capture medium in the bottom of the interior chamber.

The dry apple pomace had no effect on trap catches (Table 3). However, the number of Vespula pennsylvanica captured in traps baited with heptyl butyrate plus wet apple pomace was 72% greater than in traps baited with heptyl butyrate alone, and the mean catch in traps with this stimulus was the only mean that was significantly better than the mean catch in traps baited with heptyl butyrate plus dry apple pomace. This result indicates that immersion in water is necessary for the apple pomace to be activated, and suggests that the water dissolves attractive solutes from the apple pomace that are then released into the air inside the trap, or that microbial activity on the immersed apple pomace releases volatile attractants into the air in the interior chamber.

TABLE 3
Results of Experiment 3 (N = 12), showing better attraction and
capture of Vespula pennsylvanica to heptyl butyrate in combination
with wet apple pumice than dry apple pumice.

| | MEAN NUMBER OF WASPS |
|---|---|
| TREATMENT | CAPTURED ± SE^{a} |
| Heptyl butyrate alone | 9.8 ± 2.0 ab |
| Heptyl butyrate + dry apple pomace | 4.4 ± 0.8 a |
| Heptyl butyrate + wet apple pomace | 16.8 ± 3.5 b |

^{a}Means followed by the same letter are not significantly different, ANOVA on data transformed by log x + 1.5 followed by Tukey-Kramer HSD test, P ≦ 0.05.

### EXAMPLE 4

### Comparison of Apple Pomace and Apple Juice as Supplements for Heptyl Butyrate

A final 12-replicate experiment was set up as above, and compared wet apple pomace with apple juice. The three treatments were: 1) heptyl butyrate alone, 2) heptyl butyrate plus apple juice, and 3) heptyl butyrate plus apple pomace. In the second treatment, apple juice (Sun-Rype Products Ltd., Kelowna, B.C.) with 2-3 drops of detergent added replaced the water-detergent capture medium in the bottom of the interior trap chamber. In the third treatment, the amount of apple pomace in the plastic mesh bag immersed in the water-detergent capture medium in the bottom of the interior chamber was reduced to 5 g, which is a realistic operational dose. The experiment was set up on 29 Sep. 2006, and captured wasps were removed from the traps and counted on September 30, October 2 and October 4.

Traps baited with heptyl butyrate plus either apple juice or apple pomace captured significantly more Vespula pennsylvanica than traps baited with heptyl butyrate alone (Table 4). In both cases, the catches with apple-derived supplements were more than double that for heptyl butyrate alone (165% increase for apple pomace and 215% for apple juice), thus indicating unexpected synergism between the heptyl butyrate and the supplements. The proportion of the total catch represented by the heptyl butyrate plus apple pomace treatment rose from 32% in the first collection to 39% in the latter two collections. Surprisingly, the proportion of the total catch represented by the heptyl butyrate plus apple juice treatment fell from 51% in the first collection, to 49% in the second and 42% in the third. Thus the added attraction provided by the apple juice may not be sustainable, while the advantage provided by the apple pomace increases or remains constant over time. On the basis of this experiment, a 5 g mesh bag of apple pomace was chosen as an operational supplement to the standard heptyl butyrate lure.

TABLE 4
Results of Experiment 4 (N = 12), showing comparable
synergistic action of apple juice and apple pumice with
heptyl butyrate on capture of Vespula pennsylvanica.

| | MEAN NUMBER OF WASPS |
|---|---|
| TREATMENT | CAPTURED ± SE^{a} |
| Heptyl butyrate alone | 24.3 ± 6.7 a |
| Heptyl butyrate + apple pomace | 64.5 ± 13.4 b |
| Heptyl butyrate + apple juice | 76.6 ± 11.4 b |

^{a}Means followed by the same letter are not significantly different, ANOVA on data transformed by x + 1 followed by Tukey-Kramer HSD test, P ≦ 0.05.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

### REFERENCES

### U.S. Patent Documents

Aldrich, J. R. 2004. Chemical attractants for yellowjacket wasps. U.S. Pat. No. 6,740,319.
Landolt, P. J. 2000. Chemical attractants for yellowjackets and paper wasps. U.S. Pat. No. 6,083,498.
Long, R. H. 2003. Attractants for yellow jackets. U.S. Pat. No. 6,625,846.
Peters, C. W. 1989. Containment type insect trap. U.S. Pat. No. 4,794,724. Reexamination Certificate. 1999. U.S. Pat. No. B1 4,794,724.

### Other Publications

Akre, R. D. 1995. Our stinging friends? The ambivalent yellowjackets. Am. Entomol. 41: 21-29.
Akre, R. d., A. Greene, J. F. MacDonald, P. J. Landolt and H. G. Davis. 1981. Yellowjackets of America north of Mexico. U.S. Dept. Agric., Agric. Handb. 552. 102 pp.
Bhalla, T. C. and M. Joshi. 1994. Protein enrichment of apple pomace by co-culture of cellulolytic moulds and yeasts. World J. Microbiol. Biotech. 10: 116-117.
Boyer, J. and R. H. Liu. 2004. Apple phytochmeicals and their health benefits. Nutrition Journal 3: 5 (http:/www nutritionj.com/content/3/1/5), 15 pp.
Carson, K. J., J. L. Collins and M. P. Penfield. 1994. Unrefined, dried apple pomace as a potential food ingredient. J. Food Science 59: 1213-
Chang, V. 1998. Toxic baiting of the western yellowjacket (Hymenoptera: Vespidae) in Hawaii. J. Econ. Entomol. 81: 228-235.
Christie, G. D. 1992. Non-toxic bait trapping for yellow jackets. Pest Control, May: 30-32.
Christie, G. D. 1994. Evaluation of non-toxic bait traps for yellowjacket control. Pest Control, August: 38-39.
Davis, H. G., G. W. Eddy, T. P. McGovern and M. Beroza. 1969. Heptyl butyrate, a new synthetic attractant for yellow jackets. J. Econ. Entomol. 62: 1245.
Day, S. E. and R. L. Jeanne. 2001. Food volatiles as attractants for yellowjackets (Hymenoptera: Vespidae). Environ. Entomol. 30: 157-165.
Hang, Y. D. and E. E. Woodams. 1985. Heat evolution in solid state fermentation of apple pomace. MIRCEN Journal 1: 103-106.
Hang, Y. D., C. Y. Lee, E. E. Woodams and H. J. Cooley. 1981. Production of alcohol from apple pomace. Appl. Environ. Micrbiol. 42: 1128-1129.
Landolt, P. J. 1998. Chemical attractants for trapping yellowjackets Vespula germanica and Vespula pennsylvanica (Hymenoptera: Vespidae). Environ. Entomol. 27: 1229-1234.
Landolt, P. J. and A. L. Antonelli. 2003. Yellowjackets and paper wasps. Wash. State Univ. Coop. Ext. Bull. EB0643. 7 pp.
Landolt, P. J., C. S. Smithhisler, H. C. Reed and L. M. McDonough. 2000. Trapping social wasps (Hymenoptera: Vespidae) with acetic acid and saturated short chain alcohols. J. Econ. Entomol. 93: 1613-1618.
Landolt, P. J., H. C. Reed and D. J. Ellis. 2003. Trapping yellowjackets (Hymenoptera: Vespidae) with heptyl butyrate emitted from controlled-release dispensers. Fla. Entomol. 86: 323-328.
Landolt, P. J., A. Pantoja and D. Green. 2005. Yellowjacket wasps (Hymenoptera: Vespidae) trapped in Alaska with heptyl butyrate, acetic acid and isobutanol. J. Entomol. Soc. Brit. Columbia 102: 35-41.
Lu, Y. and L. Y. Foo. 2000. Antioxidant and radical scavenging activities of polyphenols from apple pomace. Food Chem. 68: 81-85.
Lyon, W. F. 1997. Yellowjacket. Ohio State Univ. Ext. Fact Sheet. HYG-2075-97. 7 pp.
MacDonald, J. F., R. D. Akre and W. B. Hill. 1973. Attraction of yellowjackets (Vespula spp.) to heptyl butyrate in Washington State (Hymenopters: Vespidae). Environ. Entomol. 2: 375-379.
Ross, D. R., R. H. Shukle and J. F. MacDonald. 1984. Meat extracts attractive to scavenger Vespula in eastern North America (Hymenoptera: Vespidae). J. Econ. Entomol. 77: 637-642.
Wegner, G. S. and K. K. Jordan. 2005. Comparison of three liquid lures for trapping social wasps (Hymenoptera: Vespidae). J. Econ. Entomol. 98: 664-666.
Wood, G. M., D. C. Hopkins and N. A. Schellhorn. 2006. Preference by Vespula germanica (Hymenoptera: Vespidae) for processed meats: implications for toxic baiting. J. Econ. Entomol. 99: 263-267.

What is claimed is:

1. A method of enhancing the attraction of yellowjackets and other wasps in the Family Vespidae to volatile chemical attractants, which comprises combining the attractant with an apple substance.

2. The method of claim 1 wherein the apple substance is apple pomace (also referred to as apple pumice).

3. The method of claim 2, wherein the apple pomace is held loose in a porous bag.

4. The method of claim 2, wherein the apple pomace is compressed into a pellet.

5. The method of claim 2, wherein the volatile chemical attractants include (but are not limited to) heptyl butyrate, acetic acid and isobutanol.

6. The method of claim 2, wherein the vespid wasps include (but are not limited to) Vespula pennsylvanica, Vespula germanica, Vespula maculifrons, Vespula squamosa, Vespula flavopilosa, Vespula atropilosa, Vespula acadica, Vespula consobrina, Vespula rufa, Vespula vulgaris, Dolichovespula maculata, Polistes aurifer, Polistes fuscatus, Polistes dominulus and Vespa crabro.

7. The methods of claims 2 to 5, wherein the apple pomace in effective amount is immersed in water at the bottom of a trap designed to capture vespid wasps, said trap also containing lures releasing one or more of said chemical attractants.

8. The method of claim 7, wherein the effective amount of apple pomace per trap can range from 0.5 g to 100 g.

9. The method of claim 7 wherein the trap is an Oak Stump trap.

10. A method of enhancing the attraction of yellowjackets and other wasps in the family Vespidae to a volatile chemical attractant which comprises combining the attractant with chopped dried apples.

11. A method of forming an attractant composition for yellowjackets and other wasps in the Family Vespidae which comprises combining a yellowjacket or other wasp attractant with an apple substance.

12. The method of claim 11 wherein the attractant is heptyl butyrate, acetic acid or isobutanol, and the apple substance is apple pomace or chopped dried apples.

13. A composition for attracting yellowjackets and other wasps in the Family Vespidae comprising a combination of apple pomace and one or more volatile chemical attractants.

14. The composition of claim 13, wherein the apple pomace is held loose in a porous bag.

15. The composition of claim 13, wherein the apple pomace is compressed into a pellet.

16. The composition of claim 13, wherein the volatile chemical attractants include (but are not limited to) heptyl butyrate, acetic acid and isobutanol.

17. The compositions of claims 12 to 16, wherein the apple pomace is immersed in effective amount in water at the bottom of a trap designed to capture vespulid wasps, said trap also containing lures releasing one or more of said chemical attractants.

18. The composition of claim 16, wherein the effective amount of apple pumice per trap can range from 0.5 g to 100 g.

19. A composition for attracting yellowjackets and other wasps in the family Vespidae comprising a combination of chopped dried apples and one or more volatile yellowjacket attractants.

20. The composition of claims 17 and 18, wherein said trap is comprised of a transparent cylindrical or globular receptacle with a replaceable air-tight lid, lateral entry ports leading into a transverse tube that spans the diameter of the trap and which has a partial or wholly cut-out portion at the mid point of the tube, allowing wasps to enter the large interior chamber, and a water-detergent capture medium at the bottom of the interior chamber, in which the apple pomace is immersed, and in which wasps are captured and drowned.
